(19) United States
(12) Patent Application Publication
(10) Pub. No.: US 2006/0061088 A1
(43) Pub. Date: Mar. 23, 2006

(54) Method and apparatus for internet coupon fraud deterrence

(75) Inventors: Steven J. Harrington, Webster, NY (US); Zhigang Fan, Webster, NY (US); Reiner Eschbach, Webster, NY (US); Michael A. Butler, Webster, NY (US); Edward Francis, Pittsford, NY (US); Stuart A. Schweid, Pittsford, NY (US); Shen-ge Wang, Fairport, NY (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 10/947,346

(22) Filed: Sep. 23, 2004

(51) Int. Cl. G09B 19/00

(52) U.S. Cl. 283/51

(57) ABSTRACT

Systems and methods that allow for anti-counterfeiting marks that carry user information and other data to be embedded into an original coupon design. The marks may be invisible, or visible but difficult to remove. At the receiving sides of the coupons, the embedded data are used to detect fraud and trace back the coupon users.

### BACKGROUND OF THE INVENTION

1. Field of Invention

The present invention relates generally to anti-counterfeiting patterns on a document and, more particularly, to embedding anti-counterfeiting patterns on coupons printed from internet-provided applications, wireless-provided media, or electronic media.

2. Description of Related Art

A great number of printed documents require highly reliable means of ensuring their authenticity. These documents include currency, negotiable instruments, stock certificates, checks, tickets and the like. The means employed to indicate authenticity for the document should be permanent, durable, and difficult to replicate to allow the public at large to rely on the authenticity of the documents. This latter quality is particularly important to preclude, or at least to dissuade attempts at counterfeiting the documents in order to ensure a maximum degree of confidence in the original document.

The criteria for an effective document security feature are relatively easy to formulate. Such features should be difficult to replicate to deter potential counterfeiters. The features should permit ready detection by means available to ordinary issuers or users of the final document. For banknotes and other documents on whose authenticity the public at large relies, the features should be discernible and verifiable under ordinary light conditions.

The increasing popularity of color photocopiers and other imaging systems, and the improving technical quality of color photocopiers, has led to an increase in the counterfeiting of such documentation.

A wide variety of security features for documents have been proposed previously. Examples of such security features include: optically variable devices, such as holograms and diffraction gratings; security threads or strips; microprint; watermarks; fine line or ‘filigree’ patterns; or color-shifting inks, fluorescent inks, and phosphorescent inks. However, these measures add to the complexity and production cost of the documents.

To prevent unauthorized duplication or alteration of documents, frequently special indicia or a background pattern are provided for document sheet materials. The indicia or background pattern is imposed upon the sheet material usually by some type of printing process such as offset printing, lithography, letterpress or other like mechanical systems, by a variety of photographic methods, by xerographic printing, and a host of other methods. Most of these patterns placed on sheet materials depend upon complexity and resolution to avoid ready duplication. Consequently, they add an increment of cost to the sheet material without being fully effective in many instances in providing the desired protection from unauthorized duplication or alteration.

Internet coupons are typically simpler in design, and are usually printed with home printers. As a result, they are more vulnerable to fraud. In particular, they are easily altered or counterfeited. Two-dimensional barcodes that carry user information have been introduced to internet coupons as an attempt to trace back frauds. However, these barcodes can be easily removed electronically.

### SUMMARY OF THE INVENTION

This invention provides systems and methods that allow for anti-counterfeiting marks that carry user information and other data to be embedded into an original coupon design. The marks may be invisible, or visible but difficult to remove. At the receiving sides of the coupons, the embedded data are used to detect fraud and trace back the coupon users.

In various exemplary embodiments, the systems and methods according to this invention allow anti-counterfeiting patterns to be provided on the front and back surfaces of a document which allow a document issuer to verify the authenticity of the document.

In various exemplary embodiments, the systems and methods according to this invention allow anti-counterfeiting patterns to be provided on the front and back surfaces of a document, the patterns having enhanced security protection against copying of the document.

This invention provides systems and methods that provide a low cost, anti-counterfeiting pattern on a document, such as a printed coupon for a product or service, which is easy to manufacture and yet difficult to counterfeit.

This invention provides systems and methods that provide an anti-counterfeiting pattern on a document, such as a printed coupon for a product or service, which a document issuer can verify the authenticity of the document with no additional external equipment.

### BRIEF DESCRIPTION OF THE DRAWINGS

Various exemplary embodiments of the systems and methods of this invention will be described in detail below, with reference to the following figures, in which:

FIG. 1 is a schematic illustration of an exemplary embodiment of a system for internet coupon fraud deterrence according to this invention;

FIG. 2 is a flowchart outlining one exemplary embodiment of a method for internet coupon fraud deterrence according to this invention;

FIG. 3 is a front view of an exemplary anti-counterfeiting feature on a document of the present invention;

FIG. 4 is a top view of the anti-counterfeiting feature on a document of FIG. 3;

FIG. 5 is an illustration of the first pattern of the anti-counterfeiting feature on a document of FIG. 3;

FIG. 6 is an illustration of the second pattern of the anti-counterfeiting feature on a document of FIG. 3;

FIG. 7 is a schematic view of light transmission through the see-through anti-counterfeiting feature on a document of FIG. 3;

FIG. 8 is an illustration of the first partial image and the line pattern background of the first pattern of the anti-counterfeiting feature on a document of FIG. 3;

FIG. 9 is an illustration of the second partial image and the line pattern background of the second pattern of the anti-counterfeiting feature on a document of FIG. 2;

FIG. 10 is an illustration of the superimposition of the first pattern and the second stochastic pattern when aligned to form a complete authentication image; and

FIG. 11 is an illustration of the superimposition of the first pattern and the second pattern when misaligned to cause the disappearance of the authentication image.

### DETAILED DESCRIPTION OF PREFERRED EMBODIMENTS

Typically, a user which has purchased a certain product or service for which an internet or electronic coupon, e.g., rebate coupon, exists, would typically want to print the coupon, complete any necessary information required by the manufacturer, and then submit the coupon to the manufacturer or clearing house for redemption.

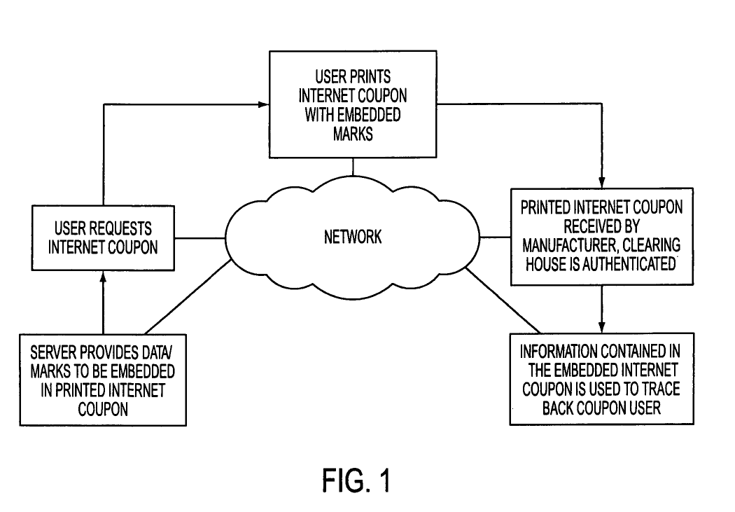

With reference to FIG. 1, in various exemplary embodiments according to systems and methods of this invention, a coupon is associated with internet marks that carry user information and other data. The internet marks that carry user information and other data are embedded into the original coupon design. The marks may be invisible, or visible but difficult to remove. The former may include digital watermarks, invisible texture marks and other invisible marks. An example of the latter is data glyphs. When data glyphs are spread over the whole coupon, it is not trivial to remove them with ordinary skills.

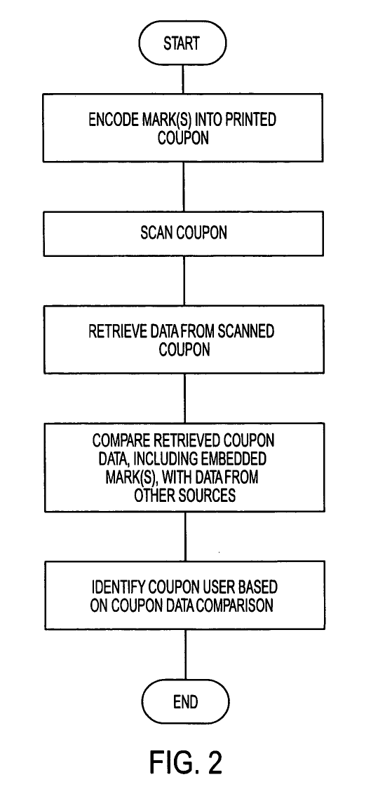

At the coupon receiving side, such as, for example, clearing houses, manufacturers and the like, the coupons are scanned and the embedded data are retrieved. The information is first used to detect fraud by comparing it to the information obtained from the other sources, such as, for example, retrieved from the 1-D barcodes printed on the original coupon. In addition, the information contained in the marks can be used to trace back the coupon users. The described process steps are outlined in FIG. 2.

In various exemplary embodiments, the embedded marks may include data glyphs. Much variability in glyph properties can be expected. For example, in these applications: (1) the amount of data stored can vary from a few bytes (a filename) to 50,000 bytes (in a paper floppy); (2) the embedded marks may be put in a single known place, or dispersed in a variable and content-determined number of places, or placed in a contiguous redundant pattern for read back with poorly aligned sensors; (3) the size of individual glyphs can vary from very small (where appearance and quantity are most important) to very large (where low-quality fax data must be reliably read); (4) the glyph error correction coding can be computed symbol-wise in one-dimensional blocks (most common), symbol-wise in two-dimensional blocks (most robust for large amounts of data), or bit-wise in two-dimensions (e.g. for protection of small amounts of data against damage correlated either horizontally or vertically); and (5) the glyphs can be placed on white background, behind black foreground, or within stippled foreground.

It should be evident that no single formatting technique will work efficiently under all these various conditions. Thus, the system will need some flexibility in choosing the glyph format to use.

In various alternative exemplary embodiments of the systems and methods according to this invention, the embedded marks may be in the form of line patterns that are aligned on the front and back surfaces of the original coupon to provide an anti-counterfeiting security device. The printed coupon document is sufficiently transparent to allow see-through of the partial image pattern on the back of the document to be superimposed on the partial image pattern on the front of the document to form a complete image if the patterns are properly aligned. The patterns will not form a complete pattern if misaligned.

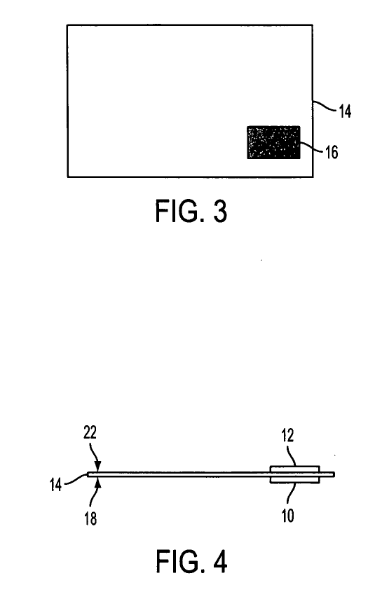

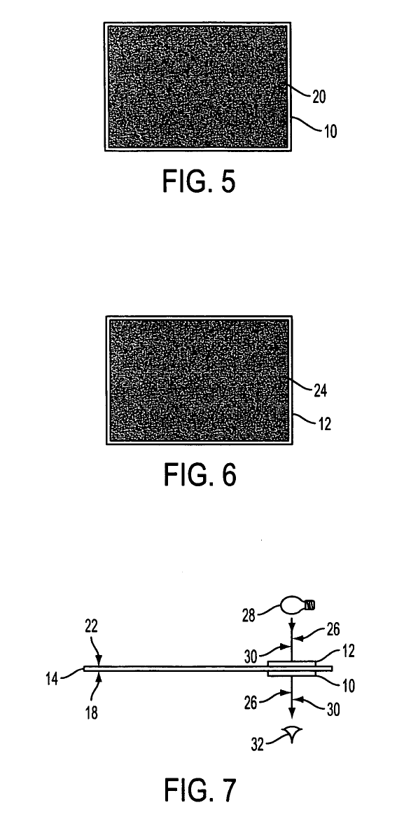

With reference to FIGS. 3 and 4, there is illustrated see-through line patterns 10, 12 on a document 14 for an anti-counterfeiting security feature 16 in accordance with this invention. A first pattern 10 is on the front surface 18 of document 14. As shown in FIG. 5, the first pattern 10 has a plurality of pixels 20 characterizing gray image data.

A second pattern 12 is on the back surface 22 of document 14. As shown in FIG. 6, the second pattern 12 has a plurality of pixels 24 characterizing gray image data. The first pattern 10 and its image data is different from the second pattern 12 and its image data. The first pattern 10 and the second pattern 12 are aligned on opposite surfaces of the document. The first and second patterns can be formed by halftoning.

The first and second patterns 10, 12 only cover a portion 16 of the front and back surface 18, 22 of the document 14. The document 14 will carry conventional printing (not shown) adjacent to the security feature portion 16. The patterns 10, 12 can be provided in any conventional manner using conventional inks such as black inks, colored inks, white inks, metallic inks, or optically variable inks.

An important aspect of the see-through patterns 10, 12 on the document 14 is its ability to permit verification of authenticity by any issuer and under normal light conditions.

The document 14 will be transparent enough, or alternately the security feature portion 16 with the patterns 10, 12 will be transparent enough, to permit see-through under normal light 26 by a document issuer. The document 14 will typically be a paper such as rag paper and the like but could also comprise a plastics material such as a plastics film or other material such as credit card material, non-wovens and the like. Alternately, the security feature portion 16 may be defined by a plastic insert within a surrounding paper document 14.

A light beam 26, such as visible light in the range of wavelengths between about 380 and 720 nanometers, from a light source 28, either natural or artificial, is incident on the document 14. The light beam 26 is either transmitted through the document, absorbed by the document, or reflected from the document. As represented by the line 30 in FIG. 7, transmitted light 26 enters the document through back surface 22, passes through the document 14, and emerges from the front surface 18 to be seen by observer 32.

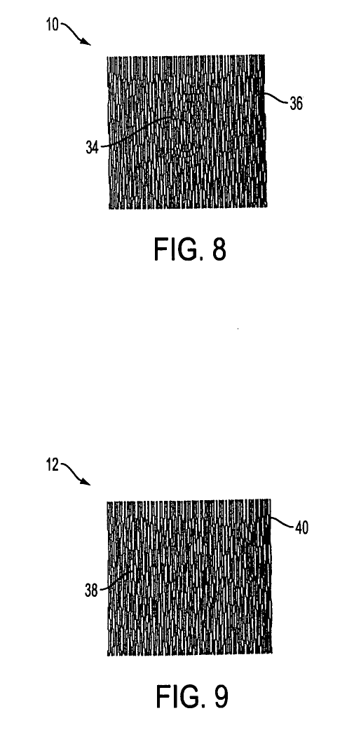

When overlapping the second pattern 12 during see-through, the first pattern 10, as seen in FIG. 8, has a first partial image 34 and a background pattern of a plurality of vertical parallel lines 36 formed from the gray image data. When overlapping the first pattern 10 during see-through, the second pattern 12, as seen in FIG. 9, has a second partial image 38 and a background pattern of a plurality of vertical parallel lines 40 formed from the gray image data.

Returning to FIG. 7, an observer 32 viewing the document 14 from the front side 18 with the light 26 behind the back side 22 of the document will “see through” the document 14 and view the second pattern 12 on the back surface 22 aligned with and superimposed on the first pattern 10 on the front surface 18.

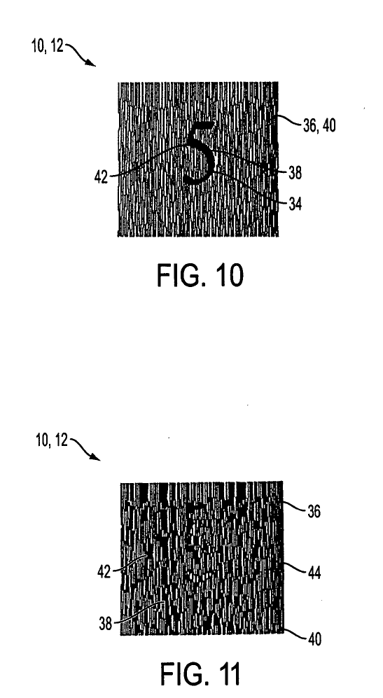

As shown in FIG. 10, the vertical parallel lines 36 of the pattern 10 on the front surface 18 are superimposed on the vertical parallel lines 40 of the pattern 12 on the back surface 22. The second partial image 38 on the back surface 22 is aligned with the complementary first partial image 34 on the front surface 18 to form a complete image 42. The resulting complete image 42 serves as an authentication mark for the document.

Preferably, the partial images 34, 38 of the first and second patterns 10, 12 each define a characteristic image. The first and second pattern define recognizable patterns (such as security patterns) or images such as geometric shapes, graphic illustrations, alphanumeric characters and other curvilinear patterns. This enables the document easily to be authenticated either by the eye of the issuer or by a machine in the case of a machine readable image.

As shown in FIG. 11, if the first pattern 10 on the front surface 18 of the document 14 is misaligned or not in perfect registration with the second pattern 12 on the back surface 22, then an observer will not be able to view the authentication image 42. The disappearance of the authentication image 42 is caused by the phase shift between the background line patterns and/or the angular rotation of the background line patterns relative to each other. The disappearance of the authentication image 42 serves as a sign of counterfeiting for the document. The second partial image 38 on the back surface 22 is misaligned with the first partial image 34 on the front surface 18 upon see-through of the document 14 with a light behind the document.

Printing of the halftoning patterns 10, 12 on the document 14 is normally carried out with specialized lithographic presses which allow simultaneous front and back surface 18, 22 printing during one printing run. In this way, the tolerances applied to the patterns 10, 12 are typically a fraction of a millimeter and any variation caused by counterfeiting by printing both sides 18, 22 during different printing runs can be quickly noticed. By printing on both sides 18, 22 in a single impression, misregister due to variations in the dimensions and thickness of the document 14 caused by change of moisture content or heating and the like are avoided. In all cases, the first and second patterns 10, 12 can be provided by printing such as offset, gravure or screen printing or by any other suitable technique such as a transfer process.

The primary advantage of a see-through security feature is the difficulty in counterfeiting such features. Partly, this is due to the need to achieve exact registration between the patterns on each side of the document and partly due to the fact that the counterfeiter may not even realize that the feature exists.

A high level of transparency for the document 14 is advantageous since it allows the use of the patterns 10, 12 which cannot normally be distinguished due to problems of light diffusion as light passes through the substrate. Specialty colors for the patterns 10, 12 are permitted because they are more difficult for a counterfeiter to faithfully reproduce with a color copier, printer or scanner.

The front and back partial images of the first and second patterns are printed in perfect registration and alignment.

The design of the partial images and the patterns is done so that any slight misalignment would be obvious through the disappearance of the authentication image when viewed in transmission and hence would be an indication that the document was counterfeit.

If an almost perfect registration can be achieved in the original printing, the present invention can be applied to detect counterfeit copies that are produced by equipment with less registration accuracy by the disappearance of the authentication image. The present invention provides a better detection resolution. The patterns are highly sensitive to mis-registration and misalignment.

Halftoning as used in the present invention refers to techniques that create the visual illusion of gray scale using a dot pattern that has only two levels of gray. A normal printing process is binary in nature in that it cannot adjust the density of ink for each spot on the paper. Rather, it can only either print an ink on a spot or leave it blank. For black ink on white paper, the process makes the spot either black or white. To print pictures with gray tones like the patterns on the document, halftoning must be used.

Halftoning is a binary encoding method. The basic idea is to print black points or groups of black points in such a way that the local point density is roughly equal to the average gray value in the corresponding regions of the source picture. The printing is controlled in such a fine fashion that the human eye cannot completely resolve the individual printed points or individual groups of points. The printed picture then appears to have continuous gray tones because of the spatial integration performed by the eye. The high resolution of a printer that cannot be fully perceived by the human eye is used to create an illusion of gray scale.

The halftone screen is used to create the halftone patterns 10, 12 printed on the document 14. The frequency of the screen and the printed pattern is high (usually 300 dpi or higher) relative to the resolving capability of the eye. A halftone image can be obtained by thresholding, pixel by pixel, a gray level source image against a uniformly distributed random noise or dither.

A stochastic screen can be used to produce the invisible partial images and line patterns of the present invention. A stochastic halftone cell is a large threshold array that produces random appearing patterns in the halftone image. To produce an invisible image pattern, at least one additional stochastic cell is produced and used to incorporate image pattern information into the document. In the following embodiment only one additional stochastic screen cell will be described. This is not intended to limit the number of cells that can be used, since the extension to more stochastic screen cells is straightforward.

To produce an invisible image pattern, a first stochastic screen is produced to reproduce a gray image with acceptable image quality. A second stochastic screen is produced that is related to the first. Over most of the two halftone cells, the thresholds are identical, and therefore the patterns they produce are correlated. Over a part of the second halftone cell, the thresholds are randomized so that in this region the two cells are uncorrelated. The locations of the thresholds within this area are optimized a second time to produce pleasing patterns. In this way, the second stochastic cell produces patterns of the same image quality as the first cell. When an image is halftoned with these two cells and the images overlaid, the regions that are uncorrelated will appear darker. By alternating the two halftone cells, image pattern information, can be incorporated into the halftoned image.

The present invention allows for a gray pattern to be used on a document, where the gray pattern can be generated using a halftoning process to produce a desirable gray.

Since the patterns are both based on the same random screen optimization or similar random screen optimizations, the patterns look approximately identical. However, when one screen is superimposed on another screen, as for example, by see-through on a document in alignment and superposition, the correlation and non-correlation between the images becomes apparent.

This invention has been described in conjunction with the exemplary embodiments outlined above. Various alternatives, modifications, variations, and/or improvements are within the spirit and scope of the invention, whether known or presently unforeseen. Accordingly, the exemplary embodiments of the invention, as set forth above, are intended to be illustrative, not limiting. Various changes may be made without departing from the spirit and scope of the invention. Therefore, the invention is intended to embrace all known or later developed alternatives, modifications, variations and/or improvements.

What is claimed is:

1. A security feature for a printed electronic coupon, comprising:
a first pattern having a first partial image and a first background pattern, the first pattern being disposed on a first surface of the coupon; and
a second pattern having a second partial image and a second background pattern, said second pattern being on a second surface of the coupon, the second surface of the coupon being disposed opposite the first surface of the coupon, the coupon being sufficiently transparent.

2. The security feature of claim 1, wherein the first pattern and the second pattern are see-through such that the first pattern and the second pattern can be viewed at a substantially perpendicular angle, superimposed upon each other from the first surface of the coupon, wherein if the first pattern is aligned with the second pattern, the first partial image and the second partial image form a complete image, if the first pattern is misaligned with the second pattern, the complete image disappears, wherein lines in the first pattern and lines in the second pattern have substantially the same direction.

3. The security feature of claim 1, wherein said first pattern and said second pattern are halftones.

4. The security feature of claim 2, wherein said disappearance of said complete image is caused by phase shift and/or rotation between said first pattern and said second pattern.

5. The security feature of claim 1, wherein said first partial image and said second partial image form at least one alphanumeric character.

6. The security feature of claim 1 wherein said first partial image and said second partial image form at least one graphic illustration.

7. The security feature of claim 1, wherein said first pattern and/or said second pattern is adjacent to a printing on said first surface and/or said second surface of said coupon.

8. The security feature of claim 1, wherein said coupon is transparent only at said first pattern and said second pattern.

9. The security feature of claim 1, wherein said first pattern and said second pattern are on a plastic area of said coupon.

10. The security feature of claim 9, wherein said coupon includes a paper medium.

11. A method for applying a security feature to a print medium, the method comprising:
applying a first pattern having a first partial image and a first background pattern on a first surface of the print medium; and
applying a second pattern having a second partial image and a second background pattern on a second surface of the print medium, the second surface of the print medium being disposed opposite the first surface of the print medium, the print medium being sufficiently transparent.

12. The method of claim 11, wherein the first pattern and the second pattern are see-through such that the first pattern and the second pattern can be viewed at a substantially perpendicular angle, superimposed upon each other from the first surface of the print medium, wherein if the first pattern is aligned with the second pattern, the first partial image and the second partial image form a complete image, if the first pattern is misaligned with the second pattern, the complete image disappears, wherein lines in the first pattern and lines in the second pattern have substantially the same direction.

13. The method of claim 11, wherein said first pattern and said second pattern are halftones.

14. The method of claim 12, wherein said disappearance of said complete image is caused by phase shift and/or rotation between said first pattern and said second pattern.

15. The method of claim 11, wherein said first partial image and said second partial image form at least one alphanumeric character.

16. The method of claim 11, wherein said first partial image and said second partial image form at least one graphic illustration.

17. The method of claim 11, wherein said first pattern and/or said second pattern is printed along with printings on said first surface and/or said second surface of said print medium.

18. The method of claim 11, wherein said print medium is transparent only at said first pattern and said second pattern.

19. The method of claim 11, wherein said first pattern and said second pattern are on a plastic area of said print medium.

20. The method of claim 19, wherein said print medium includes a paper medium to print an electronic coupon.
